(19) United States
(12) Patent Application Publication
(10) Pub. No.: US 2025/0303379 A1
(43) Pub. Date: Oct. 2, 2025

(54) IMPROVEMENTS IN OR RELATING TO CATALYST CARRIERS FOR TUBULAR REACTORS

(71) Applicant: JOHNSON MATTHEY DAVY TECHNOLOGIES LIMITED, London (GB)

(72) Inventors: Rob Miles BAKER, London (GB); Jay Simon CLARKSON, Stockton-On-Tees (GB); Andrew James COE, London (GB); Gordon KELLY, Billingham (GB)

(21) Appl. No.: 18/863,201

(22) PCT Filed: Jun. 14, 2023
(86) PCT No.: PCT/GB2023/051546

§ 371 Date: Nov. 5, 2024

(30) Foreign Application Priority Data
Jun. 15, 2022 (GB) 2208816.5

(51) Int. Cl. B01J 8/00; B01J 8/06

(52) U.S. Cl. CPC B01J 8/001; B01J 8/06; B01J 2208/00654; B01J 2208/00769; B01J 2208/00805; B01J 2208/06

(57) ABSTRACT

A method of tracking use of catalyst carriers within a tubular reactor, the tubular reactor comprising a plurality of reactor tubes, each reactor tube being configured to receive a plurality of catalyst carriers, the method comprising for each of at least some of the catalyst carriers, the steps of: —marking the catalyst carrier with a carrier identifier; —reading the carrier identifier when installing the catalyst carrier into a reactor tube; and —accessing a database to retrieve and/or record installation data associated with the identified catalyst carrier.

The present disclosure relates to tracking use of catalyst carriers within a tubular reactor. In particular, it relates to a method of tracking the use of catalyst carriers within tubular reactors and a catalyst carrier tracking system.

### BACKGROUND

Conventional, so-called fixed-bed tubular, reactors comprise a reactor shell containing a plurality of tubes, which are usually cylindrical, and which are usually directly filled with catalyst particles. In use, a heat-transfer medium flows through the shell of the reactor outside these tubes and thereby adjusts the temperature of the catalyst in the tubes by heat exchange across the tube wall. Thus, where the reaction is an exothermic reaction, the heat-transfer medium will allow heat to be removed from the catalyst and where the reaction is an endothermic reaction, the heat-transfer medium will provide heat to the catalyst.

For some reactions, the heat effects of the reaction are moderate such that they are either not problematic or they can be readily managed. In some cases, the heat effects are sufficiently small that large-diameter tubes may be used. This has the benefit that there is a large volume of catalyst within the tube.

However, for more exothermic or endothermic reactions it is necessary that there is efficient heat transfer via the tube wall to the heat transfer medium to enable the conditions within the reactor to be controlled, in order to maintain a stable operating temperature to avoid detrimental effects occurring. Such effects, for exothermic reactions, may include side reactions taking place, damage to the catalyst such as by sintering of the catalytic active sites, and, in a worst case, thermal runaway. Detrimental effects for endothermic reactions may include quenching of the reaction.

To achieve the desired efficiency, the surface area of the tube wall per unit length has to be maximised. This has in the past been achieved by installing a greater number of smaller-diameter tubes. In some reactions, the size restriction means that the tubes are only of the order of about 15 to 40 mm internal diameter. However, the use of this multiplicity of tubes increases the cost and complexity of the reactor.

Thus, in an attempt to mitigate these problems, an alternative approach has been developed, in particular for more exothermic or endothermic reactions, in which the catalyst is not directly packed into the reactor tubes but is instead contained in a plurality of catalyst carriers that are configured to sit within the reactor tube.

WO2011/048361, WO2012/136971 and WO2016/050520 describe some examples of catalyst carriers configured for use in tubular reactors. WO2022/064214, WO2022/064210, WO2022/064211 and co-pending applications GB2202226.3 and GB2203700.6 disclose methods and apparatus for loading, retaining and removing catalyst carriers to, in and from such tubular reactors.

Catalyst carriers may usefully be used for a wide range of processes. Examples of suitable uses include processes and reactors for exothermic reactions such as reactions for the production of methanol, reactions for the production of ammonia, methanation reactions, shift reactions, oxidation reactions such as the formation of maleic anhydride and ethylene oxide reactions and the like. A particular example where catalyst carriers may be used is in processes and reactors for performing the Fischer-Tropsch reaction. Catalyst carriers may also be used for endothermic reactions such as pre-reforming, dehydrogenation and the like.

Each reactor tube may contain a large number of catalyst carriers, and a single tubular reactor may contain a large number of reactor tubes. Commissioning the tubular reactor for use may require installing a very large number of catalyst carriers. After a period of operation of the tubular reactor the catalyst carriers in some or all of the reactor tubes may need to be discharged and replaced, for example due to deactivation of the catalyst contained in the catalyst carriers. The discharged catalyst carriers may be sent for post-processing to regenerate or recycle the catalyst contents.

### SUMMARY OF THE DISCLOSURE

In a first aspect of the present disclosure there is provided a method of tracking the use of catalyst carriers within tubular reactors, each tubular reactor comprising a plurality of reactor tubes, each reactor tube being configured to receive a plurality of catalyst carriers, the method comprising for each of at least some of the catalyst carriers, the steps of:
marking the catalyst carrier with a carrier identifier;
reading the carrier identifier when installing the catalyst carrier into a reactor tube; and
accessing a database to retrieve and/or record installation data associated with the identified catalyst carrier.

In some examples, the carrier identifier may be read as, or just before, the catalyst carrier is being installed in the reactor tube.

Tracking the use of catalyst carriers has a number of benefits. First, when installing a catalyst carrier into a tubular reactor the installation data associated with that catalyst carrier may be retrieved from the database and this data may be used to inform a decision regarding where the catalyst carrier should be installed, for example which reactor tube and/or which position within a reactor tube should be selected. This may be particularly beneficial where the catalyst carriers installed into a tubular reactor are not all identical but differ in one or more ways. For example, the quantity and/or quality of the catalyst in the catalyst carriers may vary. Use of the installation data may enable informed decisions on installation placement to be made. In some examples, catalyst carriers containing less-active catalyst may be placed in the hottest zone of the tubular reactor near the top of each reactor tube and catalyst carriers containing more-active catalyst may be placed lower down the reactor tubes.

Secondly, when installing a catalyst carrier into a tubular reactor the installation data associated with that catalyst carrier may be retrieved from the database and this data may be used to confirm that the catalyst carrier is permitted for use with the tubular reactor. For example the installation data may be used to check that the catalyst is of the correct type and of a correct age.

Thirdly, by recording installation data when installing the catalyst carrier into a reactor tube, the installation position of each catalyst carrier within the tubular reactor may be effectively tracked. This allows, after operation of the tubular reactor, the performance of the catalyst carriers individually and/or in groups to be analysed. For example, it is enabled to carry out diagnostic tests on the catalyst carriers after use and then use the installation data to correlate the diagnostic findings with known installation locations within the tubular reactor. For example, such diagnostic analysis may enable spatial trends and patterns of performance within a single tubular reactor to be identified and also differences in performance between tubular reactors.

Fourthly, by recording installation data when installing the catalyst carrier into a reactor tube, post-discharge treatment of the catalyst carriers may be carried out more efficiently. For example, by being able to identify the installation location of individual and/or groups of catalyst carriers and the period of time they have been used, the recycling, regeneration and/or reuse of the catalyst carriers may be differentiated based on the operative conditions they have been exposed to.

In some examples, the installation data may comprise one or more of:
characteristic data of the catalyst carrier;
current usage data of the catalyst carrier; and
historical usage data of the catalyst carrier.

Current usage data refers to data associated with the current installation of the catalyst carrier, i.e. the location where the catalyst carrier currently is, or is presently being installed into. Historical usage data refers to one or more previous installations of the catalyst carrier, e.g. previous uses of the catalyst carrier in either the same or a different reactor tube and/or tubular reactor.

The characteristic data of the catalyst carrier may, for example, represent one or more of:
a manufacturing or reconditioning date of the catalyst carrier;
a size and/or shape of the catalyst carrier;
a catalyst type contained in the catalyst carrier including, for example, batch number;
a catalyst quantity contained in the catalyst carrier; and
whether the catalyst carrier is configured to receive a thermocouple.

Preferably, at least the current usage data is recorded in the database each time that the catalyst carrier is installed into a reactor tube. In this way, the database may contain an up-to-date record of the current location of the catalyst carrier.

The current usage data of the catalyst carrier may, for example, represent one or more of:
an identity of the tubular reactor in which the catalyst carrier is presently being installed;
an identity of the reactor tube in which the catalyst carrier is presently being installed;
a position, optionally an ordinal position, of the catalyst carrier within the reactor tube in which the catalyst carrier is presently being installed; and
a date and/or time of installation of the catalyst carrier into the reactor tube.

The historical usage data of the catalyst carrier may, for example, represent one or more of:
an identity of one or more tubular reactors in which the catalyst carrier has previously been installed;
an identity of one or more reactor tubes in which the catalyst carrier has previously been installed;
a position, optionally an ordinal position, of the catalyst carrier within one or more reactor tubes in which the catalyst carrier has previously been installed; and
a date and/or time of one or more previous installations of the catalyst carrier into one or more reactor tubes, typically including the corresponding date and/or time of discharge.

The historical usage data may include data for a part or a whole of the previous operating life of the catalyst carrier. In some examples, the historical usage data may cover a period of the operating life of the catalyst carrier since its most recent regeneration or reconditioning. The historical usage data may also represent a pressure drop in a tubular reactor in which the catalyst carrier has previously been installed during a period of operation of the catalyst carrier.

In some examples the method further comprises using the installation data retrieved from the database to select an installation position when installing the catalyst carrier into a tubular reactor.

In some examples selecting an installation position may comprise selecting a reactor tube to receive the identified catalyst carrier and/or selecting an ordinal position of the catalyst carrier within a reactor tube.

The method may further comprise:
discharging the catalyst carrier from the reactor tube following a period of operation of the tubular reactor;
reading the carrier identifier; and
recording in the database an exposure time of the catalyst carrier associated with the period of operation of the tubular reactor;
optionally recording in the database the pressure drop of the reactor tube before and after the period of operation.

The exposure time may, for example, be the period of time that the catalyst carrier was installed, or the period of time that the tubular reactor was operating while the catalyst carrier was installed, or may be the period of time when one or more reactants were actually flowed through the catalyst carrier.

In some examples the method comprises using the installation data in the database to identify one or more installation positions of the catalyst carrier within one or more tubular reactors during one or more previous installations.

In some examples the method comprises using the installation data to calculate a cumulative exposure time of the catalyst carrier over one or more previous installations.

Preferably the method further comprises using the installation position to determine a processing regime for the catalyst carrier.

Preferably the method is performed for most, and most preferably all, of the catalyst carriers installed into a tubular reactor.

In some examples each catalyst carrier is marked with a unique carrier identifier representing a single catalyst carrier. This permits the most granular tracking and analysis of the catalyst carriers to be performed. In some alternative examples, the catalyst carrier may be marked with a carrier identifier representing a group of catalyst carriers, optionally a group of catalyst carriers that share a common characteristic. For example, catalyst carriers configured for installation in a particular zone of the tubular reactor may be marked with a common carrier identifier. A zone of the tubular reactor may be a vertical zone of the tubular reactor, such as an upper third, middle third or lower third. A zone of the tubular reactor may be a radial region of the tubular reactor, such as an outer annular third, middle annulus or central region.

In some examples the carrier identifier may comprise one or more of: a serial number, a one-dimensional code, e.g. a barcode, a two-dimensional code, e.g. a QR code, a colour code, a pictogram, a patterned code, a radio-frequency code, e.g. a RFID tag, and an etching or pattern in relief.

In some examples, the carrier identifier may be read visually by the human eye, However, in preferred examples, the method further comprises scanning the carrier identifier using a reader. For example, the reader may comprise a barcode reader, a camera, or an RFID reader.

In some examples the reader may comprise a part of an installation tool for installing the catalyst carrier into the reactor tube. The reader may be configured to scan the catalyst carrier simultaneously to installing the catalyst carrier into the reactor tube.

In some other examples, the reader may comprise a hand-held reader. For example, the reader may comprise a part of a portable computing unit, for example a mobile phone, a tablet computer, a PDA, or a laptop computer. The reader may permit the carrier identifier to be identified by a user stationed within a headspace of the tubular reactor, i.e. at the location for installing the catalyst carriers.

In some examples the method may further comprise marking each of at least some of the reactor tubes with a tube identifier, and reading the tube identifier when installing the catalyst carrier into a reactor tube.

In some examples accessing the database may be carried out at or near the location of the tubular reactor. For example the database may be hosted on a portable computing unit, for example a mobile phone, a tablet computer, a PDA, or a laptop computer that is present at the tubular reactor, for example in the headspace during installation.

In other examples accessing the database may involve communicating with a remote resource spatially distant from the tubular reactor. For example the database may be hosted on a virtual or physical server located at another place. Access to the database may be by a suitable network connection, for example over a wired or wireless network. A public data network may be utilised for communication.

The database may be a manually paper-based database. However, for reasons of operational efficiency, it is preferred that the database is a computerised database. The database may be operatively linked to a database user interface configured to permit input of data and queries to the database and retrieval of results and data from the database.

In a second aspect of the present disclosure there is provided a catalyst carrier tracking system comprising:
a plurality of catalyst carriers, each being marked with a carrier identifier;
one or more readers for reading the carrier identifiers; and
a database containing installation data associated with the plurality of catalyst carriers.

The installation data may comprise for one or more of:
characteristic data of the catalyst carriers;
current usage data of the catalyst carriers; and
historical usage data of the catalyst carriers.

The characteristic data of the catalyst carriers may represent one or more of:
a manufacturing or reconditioning date of the catalyst carriers;
a size and/or shape of the catalyst carriers;
a catalyst type contained in the catalyst carriers including, for example, batch number;
a catalyst quantity contained in the catalyst carriers; and
whether the catalyst carriers are configured to receive a thermocouple.

The current usage data of the catalyst carriers may represent one or more of:
an identity of the tubular reactor in which the catalyst carriers are presently installed or being installed;
an identity of the reactor tubes in which the catalyst carriers are presently installed or being installed;
a position, optionally an ordinal position, of the catalyst carriers within the reactor tubes in which the catalyst carriers are presently installed or being installed; and
a date and/or time of installation of the catalyst carriers into the reactor tubes.

The historical usage data of the catalyst carriers may represent one or more of:
an identity of one or more tubular reactors in which the catalyst carriers have previously been installed;
an identity of one or more reactor tubes in which the catalyst carriers have previously been installed;
a position, optionally an ordinal position, of the catalyst carriers within one or more reactor tubes in which the catalyst carriers have previously been installed; and
a date and/or time of one or more previous installations of the catalyst carriers into one or more reactor tubes, typically including the corresponding date and/or time of discharge;

The historical usage data may also represent a pressure drop in a tubular reactor in which the catalyst carrier has previously been installed during a period of operation of the catalyst carrier.

The catalyst carriers of the present disclosure may be filled or partially filled with any catalyst suitable for the intended reaction. For example, a Fischer-Tropsch catalyst may be used for the Fischer-Tropsch reaction. Cobalt-containing Fischer-Tropsch catalysts are preferred. The catalyst may be provided as catalyst particles or a catalyst monolith. The catalyst may be provided as a single bed of catalyst or multiple beds of catalyst. The catalyst carrier may be configured to promote axial and/or radial flow through the catalyst. In some embodiments the catalyst carrier may be configured to preferentially promote radial flow through the catalyst.

The catalyst carrier of the present disclosure may be formed of any suitable material. Such material will generally be selected to withstand the operating conditions of the tubular reactor. The catalyst carrier may be fabricated from carbon steel, aluminium, stainless steel, other alloys or any material able to withstand the reaction conditions.

### BRIEF DESCRIPTION OF THE DRAWINGS

Embodiments of the present disclosure will now be described, by way of example only, with reference to the accompanying drawings, in which:

FIG. 1 is a schematic side view of a tubular reactor;

FIG. 2 is a schematic view of an upper portion of the tubular reactor of FIG. 1;

FIG. 3 is a schematic diagram of a catalyst carrier tracking system according to the present disclosure;

FIG. 4 is a flowchart of a method according to the present disclosure;

FIG. 5 is a perspective view of a catalyst carrier for use in the tubular reactor of FIG. 1;

FIG. 6 is a cross-sectional view of the catalyst carrier of FIG. 5; and

FIG. 7 is an exploded perspective view of the catalyst carrier of FIG. 5.

### DETAILED DESCRIPTION

In the following, aspects and embodiments of the present disclosure will be described, by way of example only, with reference to a vertically orientated tubular reactor having a plurality of vertical reactor tubes extending between an upper tube sheet and a lower tube sheet. However, it will be understood that the present disclosure may also be applied to other configurations of tubular reactor that may adopt other orientations.

Additionally, in this specification any reference to orientation; for example, terms such as top, bottom, upper, lower, above, below and the like is used with regard to the orientation of the parts as illustrated in the drawings being referenced but is not to be seen as restrictive on the potential orientation of such parts in actual use. For example, a part described as being orientated vertically may also be orientated horizontally.

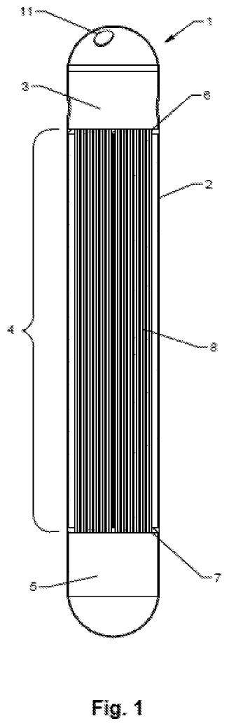

FIG. 1 shows a typical layout of a tubular reactor 1 of the present disclosure. The tubular reactor 1 comprises a housing 2. The interior of the housing may be divided into a head space 3, a heat-exchange zone 4 and a footer space 5 by two tube sheets—an upper tube sheet 6 and a lower tube sheet 7. The upper tube sheet 6 separates the head space 3 from the heat-exchange zone 4. The lower tube sheet 7 separate the footer space 5 from the heat-exchange zone 4.

A plurality of reactor tubes 8 extend between the upper tube sheet 6 and the lower tube sheet 7. A large number of reactor tubes 8 may be provided, for example between 20 and 5000 reactor tubes 8 may be present. Each reactor tube 8 may have, for example, an internal diameter of between 20 and 150 mm. In some embodiments the internal diameter may be about 85 mm.

Each reactor tube 8 is intended to be filled or substantially filled with a stacked arrangement of catalyst carriers 10. In particular, it is typically desired that the catalyst carriers 10 cover all or substantially all of the length of the reactor tube 8 between the upper tube sheet 6 and the lower tube sheet 7, i.e. that they cover all or substantially all of the length of the heat-exchange zone 4.

The head space 3 may provide access to an upper end of the reactor tubes 8 to allow loading of the catalyst carriers 10 into the reactor tubes 8. An access opening 11 may be provided in the housing 2 to allow access to the head space 3. The access opening 11 may, for example, be a manhole or other access panel that can be selectively opened and closed.

The footer space 5 may provide access to the lower end of the reactor tubes 8 to allow unloading of the catalyst carriers 10 from the reactor tubes 8.

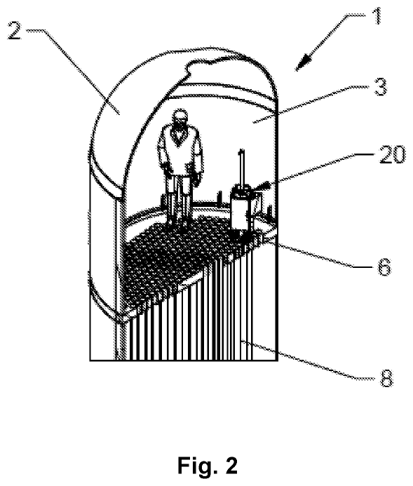

FIG. 2 illustrates an example of an installation tool 20 that may be used to install the catalyst carriers 10 into the reactor tubes 8. The installation tool 20 may comprise an installation frame, an hydraulic ram mounted to the installation frame, and one or more anchors for anchoring the installation frame to the upper tube sheet 6 of the tubular reactor 1. The anchors function to releasably engage the installation frame, and hence the installation tool 20, to the tubular reactor 1. The installation tool may form part of an installation system that additionally comprises a source of motive power. The source of motive power may be located outside the tubular reactor 1 and configured to move the movable ram of the installation tool 20.

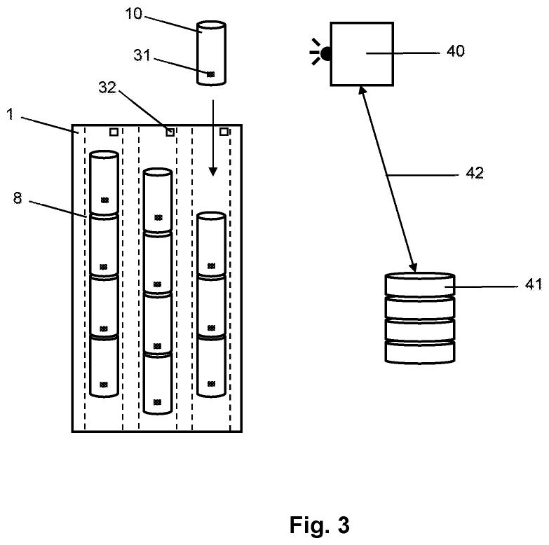

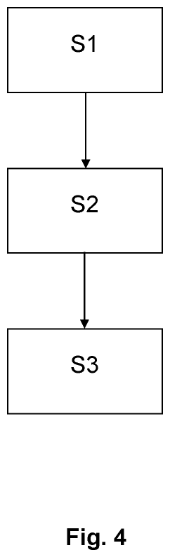

According to the present disclosure a catalyst carrier tracking system and a method of tracking the use of catalyst carriers 10 within tubular reactors 1 is provided. In general, as illustrated in FIG. 3, the catalyst carrier tracking system comprises a plurality of catalyst carriers 10, each being marked with a carrier identifier 31, one or more readers 40 for reading the carrier identifiers 31, and a database 41 containing installation data associated with the plurality of catalyst carriers 10. As illustrated in FIG. 4, the method comprises for one or more catalyst carriers 10, in a first step, S1, marking the catalyst carrier 10 with the carrier identifier 31. Then in step, S2, the method comprises reading the carrier identifier 31 when installing the catalyst carrier 10 into the reactor tube 8. Then, in step, S3, the method comprises accessing the database 41 to retrieve and/or record installation data associated with the identified catalyst carrier 10.

Preferably the method is performed for most, and most preferably all, of the catalyst carriers 10 installed into the tubular reactor 1.

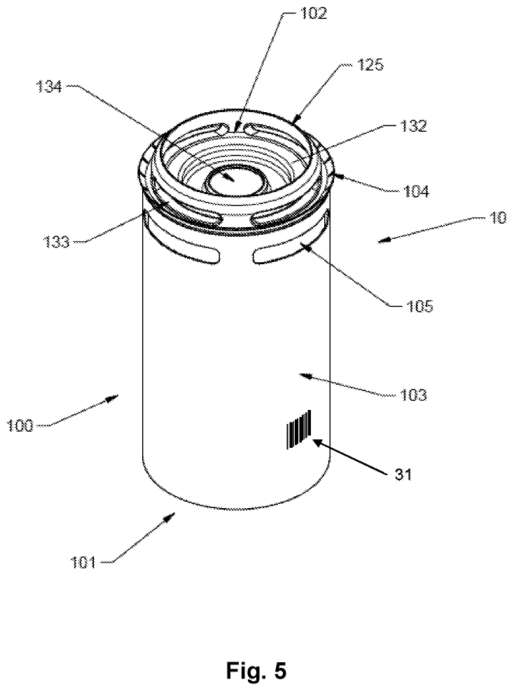

To better understand the present disclosure, an example of a general configuration of a catalyst carrier 10 will first be described with reference to FIGS. 5 to 7. However, it will be understood that the catalyst carriers 10 may take various forms. For example, as well as the examples described herein, the catalyst carriers 10 may take other general configurations including but not limited to those disclosed in WO2011/048361, WO2012/136971 and WO2016/050520, the contents of which are herein incorporated by reference in their entirety.

Each catalyst carrier 10 may generally comprise a container that is sized such that it is of a smaller dimension than the internal dimension of the reactor tube 8 into which it is to be placed in use. Typically, a seal will be provided that is sized such that it interacts with the inner wall of the reactor tube 8 when the catalyst carrier 10 is in position within the reactor tube 8. Parameters such as carrier length and diameter may be selected to accommodate different reactions and configurations of reactor tube 8.

As shown in FIGS. 5 to 7, the container 100 may generally have a bottom surface 101 that closes a lower end of the container 100 and a top surface 102 at an upper end of the container 100. A carrier outer wall 103 may extend from the bottom surface 101 to the top surface 102. A seal 104 may extend from the container 100 by a distance which extends beyond the carrier outer wall 103. The carrier outer wall 103 may have apertures 105 located below the seal 104.

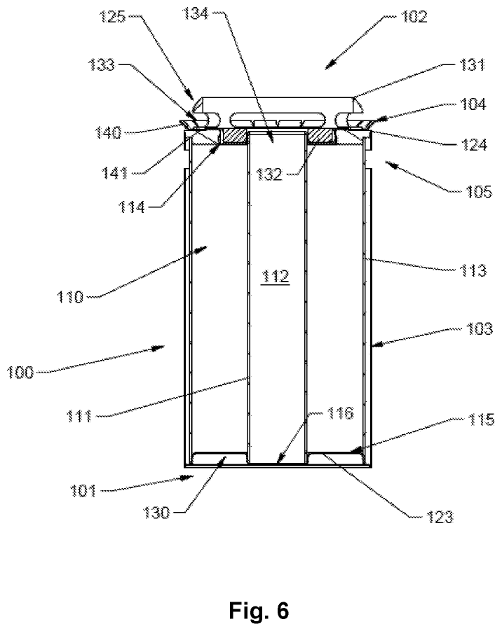

As shown in FIG. 6, the catalyst carrier 10 may more particularly comprise an annular container 110 for holding catalyst in use. The annular container 110 may comprise a perforated inner container wall 111 that defines an inner channel 112 and a perforated outer container wall 113 that may be concentrically arranged about the perforated inner container wall 111. An annular top surface 114 may close an upper end of the annular container 110 and an annular bottom surface 115 may close a lower end of the annular container 110. A lower end of the inner channel 112 may be closed off by a channel end surface 116 except for one or more drain apertures (not shown) that may be provided in the lower end of the inner channel 112. The channel end surface 116 may be formed integrally or separately to the inner container wall 111.

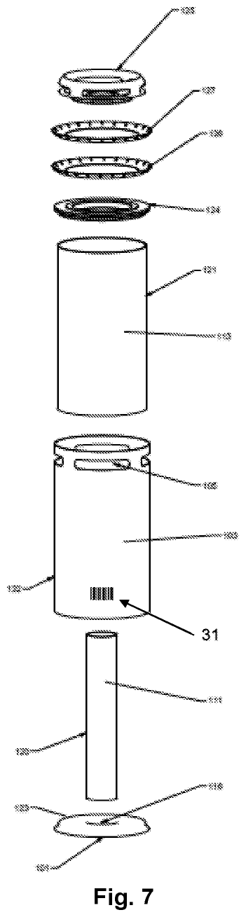

As shown in the exploded view of FIG. 7, the catalyst carrier 10 may be formed from a number of individual components that may be assembled together by any suitable means, including for example welding. In some embodiments such components may include a perforated inner tube 120, a perforated intermediate tube 121, an outer tube 122, a bottom cap 123, an annular top ring 124, a top cap 125 and an annular seal ring 126.

The catalyst carrier 10 may be formed of any suitable material. Such material will generally be selected to withstand the operating conditions of the reactor. Generally, the catalyst carrier will be fabricated from carbon steel, aluminium, stainless steel, other alloys or any material able to withstand the reaction conditions.

Suitable thicknesses for the components will be of the order of about 0.1 mm to about 1.0 mm, preferably of the order of about 0.3 mm to about 1.0 mm.

The perforated inner tube 120 may comprise the perforated inner container wall 111. The perforated intermediate tube 121 may comprise the perforated outer container wall 113. The outer tube 122 may comprise the carrier outer wall 103 and define the apertures 105. The bottom cap 123 may comprise the bottom surface 101 and/or the annular bottom surface 115. The bottom cap 123 may also extend across the perforated inner tube 120 to comprise the channel end surface 116. The annular top ring 124 and the top cap 125 may comprise the annular top surface 114 and may comprise at least part of the top surface 102. The annular seal ring 126 may comprise the seal 104.

The size of the perforations in the perforated inner tube 120 and the perforated intermediate tube 121 will be selected such as to allow uniform flow of reactant(s) and product(s) through the catalyst while maintaining the catalyst within the annular container 110. It will therefore be understood that their size will depend on the size of the catalyst particles being used. In an alternative arrangement the perforations may be sized such that they are larger but have a filter mesh covering the perforations to ensure catalyst is maintained within the annular container 110.

It will be understood that the perforations may be of any suitable configuration. Indeed, where a wall or tube is described as perforated, all that is required is that there is means to allow the reactants and products to pass through the walls or tubes.

The bottom surface 101, for example the bottom cap 123, may be shaped to engage with an upper end of another catalyst carrier 10. For example, the bottom surface 101 may comprise an annular recess 130 around the perforated inner tube 120. The top cap 125 may be shaped to engage in the annular recess 130 of another catalyst carrier 10. For example, the top cap 125 may comprise an annular ring 131 that upstands from an annular plug body 132. The annular ring 131 may be shaped and sized to be received in the annular recess 130.

The bottom surface 101, for example the bottom cap 123 and/or channel end surface 116 may include one or more drain holes. Where one or more drain holes are present, they may be covered by a filter mesh.

The annular top ring 124 may be shaped and sized to engage in an upper end of the outer tube 122. The annular plug body 132 of the top cap 125 may have an outer diameter configured to engage with a central aperture of the annular top ring 124. Engagement of the top cap 125 with the annular top ring 124 may function to sandwich and retain the annular seal ring 126 in position.

The top cap 125 may comprise a central inlet 134 in the annular plug body 132 for enabling entry of liquids and gases into the upper end of the inner channel 112. The annular ring 131 may comprise lateral apertures 133 than enable liquids and gases to reach the central inlet 134.

The carrier outer wall 103 may be smooth or it may be shaped. Suitable shapes include pleats, corrugations, and the like.

The apertures 105 in the carrier outer wall 103 may be of any configuration. In some embodiments, the apertures 105 may be holes or slots.

The carrier outer wall 103 may continue above the seal 104. Thus the seal 104 may be located at the top of the catalyst carrier 10, optionally as part of the top surface 102, or it may be located at a suitable point on the carrier outer wall 103 provided that it is located above the apertures 105 in the carrier outer wall 103.

The seal 104 may be sufficiently compressible to accommodate the smallest diameter of the reactor tube 8. The seal 104 may generally be a flexible, sliding seal. The seal 104 may engage against an inner surface of the reactor tube 8 such that liquids and gases passing along the reactor tube 8 are preferentially directed to flow through an interior of the catalyst carrier 10. The seal 104 may, for example, be configured to form a sliding seal against the inner surface of the reactor tube 8.

In the illustrated example of FIGS. 5 to 7, the seal 104 may comprise a deformable flange 140 extending from the carrier outer wall 103 or the top surface 102 of the catalyst carrier 10. The flange 140 may be sized to be larger than the internal diameter of the reactor tube 8 such that as the catalyst carrier 10 is inserted into the reactor tube 8 it is deformed to fit inside and interact with the reactor tube 8. The deformable flange 140 comprises an outer portion of the annular seal ring 126. An inner portion 141 of the annular seal ring 126 may define a clamping surface that is sandwiched and retained between the top cap 125 and the annular top ring 124. The deformable flange 140 may be angled relative to the inner portion 141. The deformable flange 140 may be angled towards the upper end of the catalyst carrier 10.

As noted above, according to the present disclosure the catalyst carrier 10 is marked with a carrier identifier 31. In FIGS. 5 to 7, the carrier identifier 31 is shown, by way of example only, in the form of a one-dimensional barcode. In other examples the carrier identifier 31 may comprise one or more of: another form of one-dimensional code serial number, a two-dimensional code, e.g. a QR code, a colour code, a pictogram, a patterned code, a radio-frequency code, e.g. a RFID tag, and an etching or pattern in relief.

The carrier identifier 31 may be positioned at any suitable location on the catalyst carrier 10. Preferably, the carrier identifier 31 is located on the carrier outer wall 103 to allow easy reading of the carrier identifier 31 even in the situation where the catalyst carrier 10 is coupled end-to-end with other catalyst carriers 10.

The reader 40 may be a machine reader. Non-limiting examples of suitable readers include a barcode reader, a camera, and an RFID reader. The reader 40 may be a dedicated device or may be integrated as part of a device having other functions. In some examples the reader 40 may comprise a hand-held reader. For example, the reader 40 may comprise a part of a portable computing unit, for example a mobile phone, a tablet computer, a PDA, or a laptop computer. In some examples the reader 40 may comprise a part of the installation tool 20 that may be used for installing the catalyst carrier 10 into the reactor tube 8. The reader 40 may be configured to scan the carrier identifier 31 of the catalyst carrier 10 simultaneously to installing the catalyst carrier 10 into the reactor tube 8.

In some examples the method may further comprise marking each of at least some of the reactor tubes 8 with a tube identifier 32 as illustrated in FIG. 3. The tube identifier 32 may be read when installing the catalyst carrier 10 into the reactor tube 8 in order to identify and record on the database 41 the specific reactor tube 8 chosen for installation. The tube identifiers 32 may, for example, be located on the upper tube sheet of the tubular reactor 1 adjacent the upper opening of each reactor tube 8. The tube identifier 32 may be read by the same reader 40 used for reading the carrier identifiers 31 or a different reader. For example, the installation tool 20 may comprise a first reader that may be side-facing to scan the carrier identifiers 31 and a second reader that may be down-facing to read the tube identifiers 32.

The database 41 may preferably be a computerised database. The database 41 may be operatively linked to a database user interface configured to permit input of data and queries to the database 41 and retrieval of results and data from the database 41. The database 41 may be hosted on a portable device, for example a portable computing unit, for example a mobile phone, a tablet computer, a PDA, or a laptop computer, that may also be the same portable device incorporating the reader 40. Alternatively, the database 41 may be hosted remotely on, for example a physical or virtual server that is located spatially distant from the tubular reactor 1. The database 41 or database functions may be distributed across multiple devices, for example with some data-hosting, data analysis and/or data presentation being performed on a portable device local to the tubular reactor 1 and some being performed on a remote resource, e.g. a remote server.

Where the database 41 is located in whole or in part at a remote location, accessing the database 41 may comprise communicating over a suitable network connection 42, for example over a wired or wireless network. A public data network may be utilised for communication.

In use, during commissioning or re-filling of the tubular reactor 1 or at other times as required, catalyst carriers 10 may be installed into the reactor tubes 8 of the tubular reactor 1. According to the present disclosure, the catalyst carrier tracking system and method may be used to obtain, collate and utilise installation data on the catalyst carriers 10. Installation data on a catalyst carrier 10 may be obtained and/or updated on the database 41 each time its carrier identifier 31 is read by the reader 40.

The carrier identifier 31 may be read at various points during the lifecycle of the catalyst carrier 10. For example, the carrier identifier 31 may be read when first manufactured, when installed in a reactor tube 8, when discharged from a reactor tube 8, when received at a new physical location, when subjected to a processing regime (e.g. regeneration, re-filling, repair or recycling), and/or when decommissioned.

Each catalyst carrier 10 may be marked with a unique carrier identifier 31 representing a single catalyst carrier 10. This permits the most granular tracking and analysis of the catalyst carriers 10 to be performed. Alternatively, the catalyst carrier 10 may be marked with a carrier identifier 31 representing a group of catalyst carriers 10, optionally a group of catalyst carriers 10 that share a common characteristic, for example having the same type or quantity of catalyst, or the same length, or the same manufacturing date, etc.

The installation data may comprise one or more of:
characteristic data of the catalyst carrier 10;
current usage data of the catalyst carrier 10; and
historical usage data of the catalyst carrier 10.

The characteristic data of the catalyst carrier 10 may, for example, represent one or more of:
a manufacturing or reconditioning date of the catalyst carrier 10;
a size and/or shape of the catalyst carrier 10;
a catalyst type contained in the catalyst carrier 10 including, for example, batch number;
a catalyst quantity contained in the catalyst carrier 10; and
whether the catalyst carrier 10 is configured to receive a thermocouple.

Current usage data may be data associated with the current installation of the catalyst carrier 10, i.e. the location where the catalyst carrier 10 currently is, or is presently being installed into. In some examples the current usage data may be obtained and recorded in the database 41 at the point when the catalyst carrier 10 is being installed into its current reactor tube 8. The carrier identifier 31 may be read by the operative that is carrying out the installation at the time and location of installation.

In some examples the current usage data in the database 41 may be considered to remain ‘current’ until the carrier identifier 31 of that catalyst carrier 10 is next read. Preferably, at least the current usage data is recorded in the database 41 each time that the catalyst carrier 10 is installed into a reactor tube 8 or is moved location or otherwise undergoes a substantial change. In this way, the database 41 may contain an up-to-date record of the current location and/or status of the catalyst carrier 10.

The current usage data of the catalyst carrier 10 may, for example, represent one or more of:
an identity of the tubular reactor 1 in which the catalyst carrier 10 is presently being installed;
an identity of the reactor tube 8 in which the catalyst carrier 10 is presently being installed;
a position, optionally an ordinal position, of the catalyst carrier 10 within the reactor tube 8 in which the catalyst carrier 10 is presently being installed; and
a date and/or time of installation of the catalyst carrier 10 into the reactor tube 8.

The database 41 may utilise data read from the tube identifier 32 (where present) to determine the identity of the reactor tube 8 in which the catalyst carrier 10 is presently being installed. Alternatively, the identity of the reactor tube 8 may be manually recorded in the database 41 by the operative, for example by manual data entry using the portable device. Likewise, the identity of the tubular reactor 1 may, for example, be manually recorded in the database 41 by the operative, for example by manual data entry using the portable device.

The ‘three-dimensional’ location of an individual catalyst carrier 10 within the tubular reactor 1 may be identified and tracked by, for example, recording the identity of the tubular reactor 1 plus the identity of the reactor tube 8 plus the ordinal position of the catalyst carrier 10 within the reactor tube 8.

The ordinal position may be recorded as the position of the catalyst carrier 10 within the stack of catalyst carriers 10 counting either from the top or bottom of the reactor tube 8. For example, the ordinal position may be recorded as the order number of installation into the top of the reactor tube 8 such that the ‘first’ catalyst carrier 10 is located at the bottom of the reactor tube, followed by the ‘second’, ‘third’, ‘fourth’ catalyst carriers 10 stacked on top, with the ‘n^{th}’ catalyst carrier being located at the top of the reactor tube 8.

The database 41 may utilise the characteristic data of the catalyst carrier 10 (e.g. a recorded length of the catalyst carrier 10) together with the ordinal position of the catalyst carrier 10 to derive an installation height for the catalyst carrier 10.

Historical usage data may refer to one or more previous installations of the catalyst carrier 10, e.g. previous uses of the catalyst carrier 10 in either the same or a different reactor tube 8 and/or tubular reactor 1. The historical usage data of the catalyst carrier 10 may, for example, represent one or more of:
an identity of one or more tubular reactors 1 in which the catalyst carrier 10 has previously been installed;
an identity of one or more reactor tubes 8 in which the catalyst carrier 10 has previously been installed;
a position, optionally an ordinal position, of the catalyst carrier 10 within one or more reactor tubes 8 in which the catalyst carrier 10 has previously been installed; and
a date and/or time of one or more previous installations of the catalyst carrier 10 into one or more reactor tubes 8, typically including the corresponding date and/or time of discharge.

The historical usage data may also represent pressure drop in a tubular reactor in which the catalyst carrier has previously been installed during a period of operation of the catalyst carrier.

The installation data may be used to inform decisions by an operative when installing catalyst carriers 10 into a tubular reactor 1. For example the installation data retrieved from the database can be used to select an installation position. For example, the installation data may indicate that the catalyst carrier 10 would be best located in a particular zone of the tubular reactor, e.g. lower-third, mid-third or upper third. The operative may then order the catalyst carriers 10 for installation accordingly (this ordering could take place on site or off-site prior to delivery of the catalyst carriers to the tubular reactor 1). In another example, the installation data may indicate that the catalyst carrier 10 is specially configured to accommodate passage of a thermocouple. The operative may thereby ensure that for a reactor tube 8 that is to receive a thermocouple, only suitably configured catalyst carriers 10 are installed.

The installation data may also be used to analyse performance of the catalyst carriers 10. By being able to track and identify groups or individual catalyst carriers 10 the opportunities for post-operation analysis are significantly increased.

For example, the installation data may be used to track the installation position of the catalyst carrier 10 within the tubular reactor 1 during one or more previous installations.

For example, the installation data may be used to calculate an exposure time and/or a cumulative exposure time of the catalyst carrier over one or more previous installations.

The installation data may also be used to determine a processing regime for the catalyst carrier 10 after discharge from the reactor tube 8. For example, this may be a determination that the catalyst carrier 10 can be immediately re-used and re-installed in a reactor tube 8. Alternatively, the determination may be that the catalyst carrier 10 requires regeneration, or recycling, etc.

During operation, after filling the reactor tubes 8 with the catalyst carriers 10, the tubular reactor 1 is operated to pass one or more reactants through the reactor tubes 8 from the inlet end to the outlet end of each. In a tubular reactor 1 with downflow utilising catalyst carriers 10 illustrated in FIGS. 5 to 7, reactant(s) flow downwardly through each reactor tube 8 and thus first contact the top surface 102 of the uppermost catalyst carrier 10. The seal 104 blocks the passage of the reactant(s) around the side of the catalyst carrier 10. Therefore, the top surface 102 directs the reactants inwardly through the lateral apertures 133 into the central inlet 134 at the upper end of the inner channel 112 within the inner container wall 111 defined by the perforated inner tube 120. The reactant(s) then enters the annular container 110 through the perforated inner tube 120 and then passes radially through the catalyst bed towards the outer container wall 113 defined by the perforated intermediate tube 121. During this passage the reactant(s) contact the catalyst and reaction occurs to form product(s). Unreacted reactant(s) and product(s) then flow out of the annular container 110 through the perforated intermediate tube 121. The carrier outer wall 103 defined by the outer tube 122 then directs reactant(s) and product(s) upwardly between the inner surface of the carrier outer wall 103 and the perforated intermediate tube 121 until they reach the apertures 105 in the carrier outer wall 103. They are then directed through the apertures 105 and flow downwardly between the outer surface of the carrier outer wall 103 and the inner surface of the reactor tube 8 where heat transfer takes place. The unreacted reactant(s) and product(s) may then contact the top surface 102 of the underlying catalyst carrier 10 in the stacked formation and the process described above may repeat. This pattern may repeat as the reactant(s) and product(s) pass down the stacked formation until they are collected out of the lower end of the reactor tube 8. Some of the products, especially liquid products, may drain out of the inner channel 112 through the drain hole provided in the channel end surface 116 into the inner channel 112 of the underlying catalyst carrier 10. Such products may then continue to drain down the stacked formation of the catalyst carriers 10 and be collected out of the lower end of the reactor tubes 8.

1. A method of tracking the use of catalyst carriers within tubular reactors, each tubular reactor comprising a plurality of reactor tubes, each reactor tube being configured to receive a plurality of catalyst carriers, the method comprising for each of at least some of the catalyst carriers, the steps of:
marking the catalyst carrier with a carrier identifier;
reading the carrier identifier when installing the catalyst carrier into a reactor tube; and
accessing a database to retrieve and/or record installation data associated with the identified catalyst carrier.

2. The method of claim 1, wherein the installation data comprises one or more of:
characteristic data of the catalyst carrier;
current usage data of the catalyst carrier; and
historical usage data of the catalyst carrier.

3. The method of claim 2, wherein the characteristic data of the catalyst carrier represents one or more of:
a manufacturing or reconditioning date of the catalyst carrier;
a size and/or shape of the catalyst carrier;
a catalyst type contained in the catalyst carrier;
a catalyst quantity contained in the catalyst carrier; and
whether the catalyst carrier is configured to receive a thermocouple.

4. The method of claim 2, wherein at least the current usage data is recorded in the database each time that the catalyst carrier is installed into a reactor tube.

5. The method of claim 2, wherein the current usage data of the catalyst carrier represents one or more of:
an identity of the tubular reactor in which the catalyst carrier is presently being installed;
an identity of the reactor tube in which the catalyst carrier is presently being installed;
a position, optionally an ordinal position, of the catalyst carrier within the reactor tube in which the catalyst carrier is presently being installed; and
a date and/or time of installation of the catalyst carrier into the reactor tube.

6. The method of claim 2, wherein the historical usage data of the catalyst carrier represents one or more of:
an identity of one or more tubular reactors in which the catalyst carrier has previously been installed;
an identity of one or more reactor tubes in which the catalyst carrier has previously been installed;
a position, optionally an ordinal position, of the catalyst carrier within one or more reactor tubes in which the catalyst carrier has previously been installed; and
a date and/or time of one or more previous installations of the catalyst carrier into one or more reactor tubes.

7. The method of claim 1, further comprising:
using the installation data retrieved from the database to select an installation position when installing the catalyst carrier into a tubular reactor.

8. The method of claim 7, wherein selecting an installation position comprises selecting a reactor tube to receive the identified catalyst carrier and/or selecting an ordinal position of the catalyst carrier within a reactor tube.

9. The method of claim 1, further comprising:
discharging the catalyst carrier from the reactor tube following a period of operation of the tubular reactor;
reading the carrier identifier; and
recording in the database an exposure time of the catalyst carrier associated with the period of operation of the tubular reactor.

10. The method of claim 9, further comprising:
recording in the database the pressure drop of the reactor tube before and after the period of operation.

11. The method of claim 1, further comprising using the installation data in the database to identify one or more installation positions of the catalyst carrier within one or more tubular reactors during one or more previous installations.

12. The method of claim 1, further comprising using the installation data to calculate a cumulative exposure time of the catalyst carrier over one or more previous installations.

13. The method of claim 1, further comprising using the installation position to determine a processing regime for the catalyst carrier.

14. The method of claim 1, wherein the method is performed for most, and preferably all, of the catalyst carriers installed into a tubular reactor.

15. The method of claim 1, wherein each catalyst carrier is marked with a unique carrier identifier representing a single catalyst carrier.

16. The method of claim 1, wherein the catalyst carrier is marked with a carrier identifier representing a group of catalyst carriers, optionally a group of catalyst carriers that share a common characteristic.

17. The method of claim 1, wherein the carrier identifier comprises one or more of: a serial number, a one-dimensional code, e.g. a barcode, a two-dimensional code, e.g. a QR code, a colour code, a pictogram, a patterned code, a radio-frequency code, e.g. a RFID tag, and an etching or pattern in relief.

18. The method of claim 1, further comprising scanning the carrier identifier using a reader, wherein the reader comprises a barcode reader, a camera, or an RFID reader.

19. The method of claim 18, wherein the reader comprises a part of an installation tool for installing the catalyst carrier into the reactor tube.

20. The method of claim 18, wherein the reader comprises a hand-held reader; optionally wherein the reader comprises a part of a portable computing unit, for example a mobile phone, a tablet computer, a PDA, or a laptop computer.

21. The method of claim 1, further comprising marking each of at least some of the reactor tubes with a tube identifier, and reading the tube identifier when installing the catalyst carrier into a reactor tube.

22. A catalyst carrier tracking system comprising:
a plurality of catalyst carriers, each being marked with a carrier identifier;
one or more readers for reading the carrier identifiers; and
a database containing installation data associated with the plurality of catalyst carriers.

23. The catalyst carrier tracking system of claim 22, wherein the installation data comprises for one or more of:
characteristic data of the catalyst carriers;
current usage data of the catalyst carriers; and
historical usage data of the catalyst carriers.

24. The catalyst carrier tracking system of claim 23, wherein the characteristic data of the catalyst carriers represents one or more of:
a manufacturing or reconditioning date of the catalyst carriers;
a size and/or shape of the catalyst carriers;
a catalyst type contained in the catalyst carriers;
a catalyst quantity contained in the catalyst carriers; and
whether the catalyst carriers are configured to receive a thermocouple.

25. The catalyst carrier tracking system of claim 23, wherein the current usage data of the catalyst carriers represents one or more of:
an identity of the tubular reactor in which the catalyst carriers are presently installed or being installed;
an identity of the reactor tubes in which the catalyst carriers are presently installed or being installed;
a position, optionally an ordinal position, of the catalyst carriers within the reactor tubes in which the catalyst carriers are presently installed or being installed; and
a date and/or time of installation of the catalyst carriers into the reactor tubes.

26. The catalyst carrier tracking system of claim 23, wherein the historical usage data of the catalyst carriers represents one or more of:
an identity of one or more tubular reactors in which the catalyst carriers have previously been installed;
an identity of one or more reactor tubes in which the catalyst carriers have previously been installed;
a position, optionally an ordinal position, of the catalyst carriers within one or more reactor tubes in which the catalyst carriers have previously been installed; and
a date and/or time of one or more previous installations of the catalyst carriers into one or more reactor tubes.
